(19) United States
(12) Patent Application Publication
(10) Pub. No.: US 2026/0341302 A1
(43) Pub. Date: Oct. 29, 2026

(54) METHOD AND APPARATUS FOR ELECTROMAGNETIC ERASURE OF MAGNETIC STORAGE MEDIA

(71) Applicant: Data Security, Inc., Lincoln, NE (US)

(72) Inventor: Walker Arce, Omaha, NE (US)

(21) Appl. No.: 19/652,738

(22) Filed: Apr. 20, 2026

Related U.S. Application Data
(60) Provisional application No. 63/793,507, filed on Apr. 23, 2025.

(51) Int. Cl. G11B 5/012

(52) U.S. Cl. CPC G11B 5/012

(57) ABSTRACT

Systems and methods for the erasure of magnetic media are provided. In some configurations, a system for the electromagnetic erasure of magnetic storage media includes a magnetic field generator to perform a degaussing operation. The system also includes a set of position detectors that are disposed at known distances from the magnetic field generator such that a system controller can determine a characteristic of the magnetic media (e.g., velocity, length, acceleration) based on data from the position detectors. The controller is operatively coupled with the magnetic field generator and the position detectors. The controller receives data from the position detectors that is indicative of the presence of the magnetic media. The controller can then determine a characteristic of the magnetic media and control the timing of the degaussing operation based on the characteristic.

### CROSS REFERENCE TO RELATED APPLICATIONS

This application claims priority to U.S. Provisional Application No. 63/793,507, filed Apr. 23, 2025, and is incorporated herein by reference in its entirety.

### TECHNICAL FIELD

This invention relates generally methods and apparatuses for the electromagnetic erasure of magnetic storage media.

### BACKGROUND

Electromagnetic degaussing systems generate a strong magnetic field to permanently erase data on magnetic storage media like hard drives, tapes, and floppy disks by disrupting the alignment of magnetic domains on the storage medium. Electromagnetic degaussing systems typically involve the interaction or intervention of an operator, for example, to pick up the media, place it into the degausser and, in some aspects, position the media in a cavity of the degausser, and then retrieve it from the degausser for further processing or disposal. When operating an electromagnet degaussing system, properties of the magnetic media, such as its size or length may not be known.

### BRIEF DESCRIPTION OF DRAWINGS

The above needs are at least partially met through provision of the method and apparatus for electromagnetic erasure of magnetic storage media described in the following detailed description, particularly when studied in conjunction with the drawings, wherein:

FIG. 1 is a schematic diagram of a system for degaussing magnetic media, in accordance with some embodiments;

FIG. 2 is a schematic diagram of a laser gate, in accordance with some embodiments;

FIG. 3 is a schematic diagram of an apparatus for electromagnetic erasure of magnetic storage media, in accordance with some embodiments;

FIGS. 4A, 4B, and 4C are schematic diagrams of an apparatus for electromagnetic erasure of magnetic storage media, in accordance with some embodiments;

FIG. 5 is a flow diagram of a method for electromagnetic erasure of magnetic storage media, in accordance with some embodiments;

FIG. 6 is a flow diagram of a method for electromagnetic erasure of magnetic storage media, in accordance with some embodiments; and

FIGS. 7A, 7B, 7C, and 7D include equations that are employed by the systems and methods described herein, in accordance with some embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The systems and methods for electromagnetic erasure of magnetic media described herein can be used to erase data from magnetic media and, in some aspects, can be used for bulk erasure of magnetic media. The systems and methods can precisely control the timing of a degaussing operation performed by an erasure device, such as a degausser, to erase data from magnetic media. The systems and methods employ one or more position detector(s) to control the timing of the degaussing operation. The position detector(s) are disposed at an inlet of the erasure device and can be used to determine characteristics of the media, such a position, velocity, length, and/or acceleration of the media, as it travels through the system. The position detector(s) are in communication with a controller that is operatively coupled to the erasure device. The controller controls the timing of the degaussing operation based on the characteristics of the media. In some approaches, the position detectors are laser gates that include photodetectors in communication with the controller.

Capacitive discharge degaussers are one type of erasure device. Capacitive discharge degaussers store energy in capacitors and release energy as magnetic pulses to erase the media. Permanent magnet degaussers are another type of erasure device that can be used to erase magnetic media. Permanent magnet degaussers use a strong rare-earth magnet to create a constant magnetic field for erasure. Capacitive discharge degaussers can release a concentrated burst of energy while permanent magnet degaussers provide a continuous magnetic field that may be weaker overall than that provided by capacitive discharge degaussers.

As magnetic media is improved, the coercivity (e.g., the resistance to demagnetization of the media, i.e., erasing the media)) that is involved to erase the media increases. Governmental regulations may also dictate that magnetic fields of a particular strength are used for bulk erasure of magnetic media, such as those storing classified materials. For example, regulations may dictate that magnetic fields of more than 3 Teslas be used for bulk erasure of classified materials stored on magnetic media. Capacitive discharge degaussers generally possess higher coercivity compared to permanent magnet degaussers, attributable to the concentrated energy burst they produce. Consequently, capacitive discharge degaussers are capable of generating stronger magnetic fields to effectively erase data from media. However, managing the timing of the capacitive discharge during a degaussing operation can present challenges, particularly when erasing media in bulk.

Degaussing operations for a capacitive discharge degausser may involve the interaction or intervention of an operator with a degausser to insert and/or remove media from the degausser. For example, an operator may insert a media into a tray which is then pushed and latched into a degaussing coil cavity. The operator may then retrieve the media from the degausser for further processing or disposal. In another example, an operator may place the media into a slot and, after a button is pushed, the media is translated into the degaussing coil cavity by means of gravity. In yet another example, an operator may insert the media into a tray which is then translated into the degaussing coil cavity via one or more actuators.

The systems and methods described here in use a controller that is in communication with one or more position detectors and an electric field generator (e.g., a degausser). The position detectors are configured to detect position of the media relative to the degausser and, in this manner, characteristics of the media such as velocity, length, and/or acceleration of the media can be determined. The controller determines or otherwise receives data on the characteristics of the media and precisely controls the timing of the discharge of the degausser in the degaussing operation. In this manner, the media can be more easily erased in bulk. In addition, controlling the timing of the degaussing operation may allow the force imparted on the media due to the discharge of the degausser to be controlled.

The systems and methods involve monitoring the position, velocity, and acceleration of magnetic media entering a degausser. The controller may initiate the degaussing operation once the media is optimally placed within the cavity of the degausser, for example, to ensure improved or optimal placement relative to the electromagnet. For instance, the controller may initiate the degaussing operation once the media is positioned at or near the center of the electromagnet, such that the minimum or reduced amount of kinetic energy is imparted into the media and the optimum or increased amount of magnetic energy is used for degaussing.

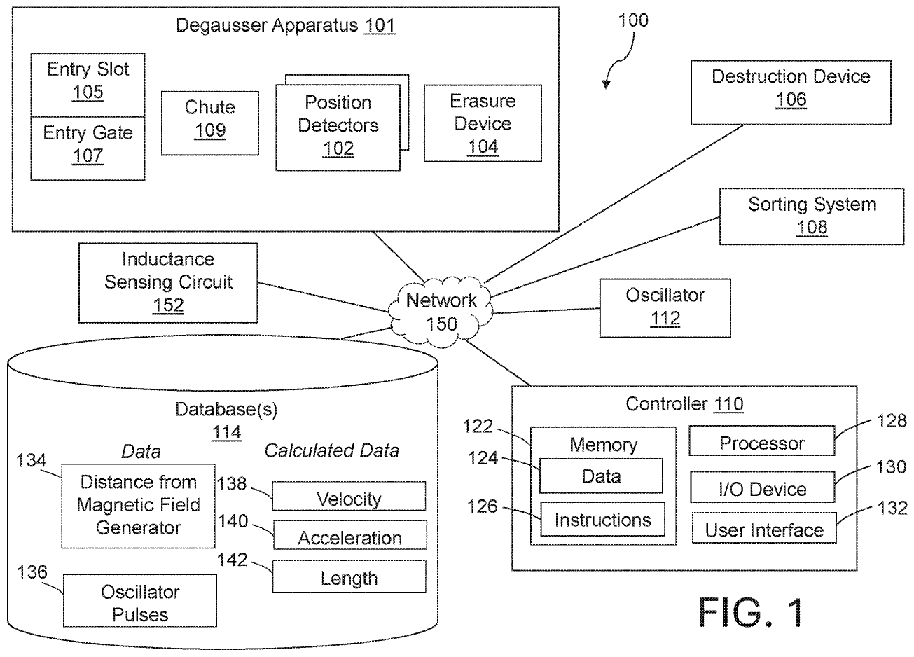

Turning to the figures, FIG. 1 shows an exemplary system 100 for electromagnetic erasure of media, such as a magnetic media. The system 100 enables control of the timing of a degaussing operation as a piece of media passes through the system 100. Accordingly, the system 100 can be used to erase media in bulk. The system 100 includes a degausser apparatus 101 and a controller from controlling a degaussing operation performed by the degausser apparatus 101. The degausser apparatus 101 includes an erasure device 104 and one or more position detectors 102 (e.g., one or more sets of position detectors 102) for sensing a position of the media relative to the erasure device 104. The system 100 may also include one or more databases 114 for storing data relevant to operating the degausser apparatus 101. In some embodiments, the system 100 also includes a destruction device 106 and/or a sorting system 108 that are disposed downstream of the degausser apparatus 101 for further handling the media that exits the degausser apparatus.

The erasure device 104 may be any suitable device that is operable to erase a magnetic media. In some embodiments, the erasure device 104 is a magnetic field generator that generates a magnetic field sufficient to erase data stored on the media. In some embodiments, the erasure device is configured to generate a magnetic field having a strength greater than about 1 Tesla, greater than about 2 Tesla, or, in some aspects, greater than about 3 Tesla. In one example, the erasure device is a capacitive discharge degausser.

In some embodiments, the degausser apparatus 101 includes a translation mechanism 109 for transporting or conveying the media through the degausser apparatus 101 and, in particular, through the erasure device 104. Any suitable translation mechanism can be employed. In some examples, the translation mechanism is an inclined channel, for example, in the form of trough, tube, shaft, or slide. The system 100 may also include one or more entry slot(s) 105 for receiving media into the degausser apparatus 101. An entry gate 107 may be coupled to each entry slot 105. The entry gate 107 may be an electrically operated gate that is interfaced with the controller 110 to regulate the introduction of media into the degausser apparatus 101.

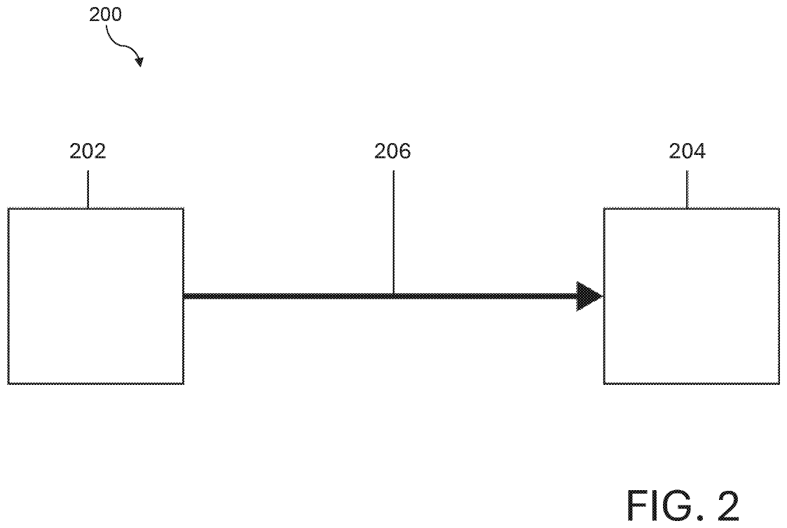

The position detector(s) 102 can be any sensor that is operable to detect or otherwise determine a position of a media passing through the degausser apparatus 101. The position detector(s) 102 are positioned at an inlet of the erasure device 104. In some embodiments, the position detector(s) 102 are disposed along the translation mechanism 109. In some embodiments, the position detector(s) 102 comprises one or more laser gates. An exemplary laser gate 200 that can be employed in the degausser apparatus 101 is shown and described with reference to FIG. 2. In some embodiments, the position detector(s) 102 include at least one of a proximity sensor (e.g., an inductive, a capacitive sensor, an ultrasonic sensor), a photoelectric sensor, a magnetic sensor (e.g., a hall effect sensor), or a position sensor (e.g., a linear variable differential transformer (LVDT)).

In some embodiments, the system 100 includes the destruction device 106. The destruction device 106 may be disposed at the outlet of the erasure device 104. That is, the destruction device 106 may be positioned downstream of the erasure device 104. In one exemplary configuration, the destruction device 106 is interfaced with an exit slot of the degausser apparatus 101. The destruction device 106 may be configured for physical destruction of the media, for example, to physically damage the media beyond recovery. Suitable destruction devices include but are not limited to shredders, crushers, drill presses, etc.

In some embodiments, the system 100 includes the sorting system 108. The sorting system 108 may be disposed at the outlet of the erasure device 104. That is, the sorting system 108 may be disposed downstream of the erasure device 104. In one exemplary configuration, the destruction device 106 is interfaced with an exit slot of the degausser apparatus 101. The sorting system 108 can employ any suitable sorting device to separate media that exits the degausser apparatus 101. In some embodiments, the sorting system 108 is used in combination with a plurality of destruction devices 106 and is operable to select which of the plurality of destruction devices a particular media passing through the system 100 is placed in. In some examples, the sorting system 108 is configured to separate media based on media size. In other examples, the sorting system 108 is configured to separate media based on media type.

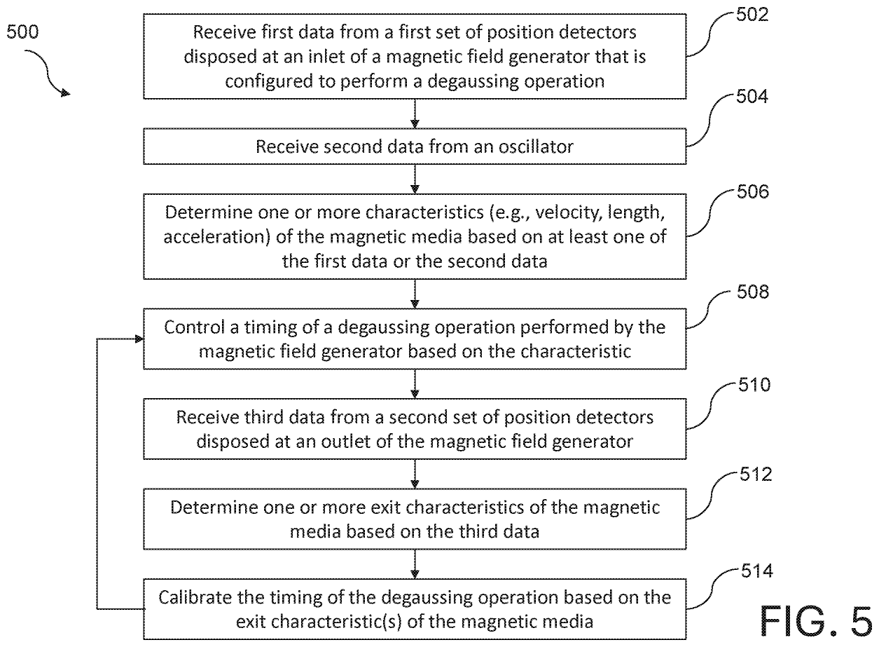

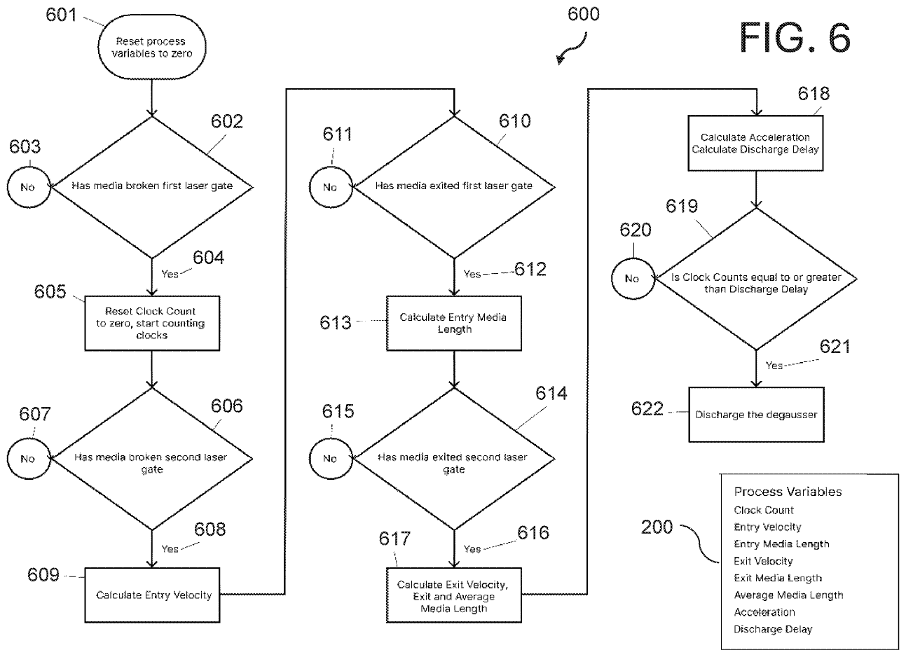

The controller 110 is communicatively coupled to the degausser apparatus 101, the destruction device 106, the sorting system 108, the oscillator, and/or the database(s) 114. The controller 110 may function as a computing device to perform the functions and methods described herein. For example, the controller 110 may perform one or more of the methods described in FIGS. 5 and 6. Further, the controller 110 may be configured to operate the erasure device 104 based on data received from the position detectors 102 and/or the database(s) 114.

The controller 110 may include one or more processors 128, input/output (I/O) devices 130, and memory devices 122. The processors 128 may include any suitable processing device such as a microprocessor, microcontroller, integrated circuit, logic device, or other suitable processing device. The processors 128 may be used to execute or assist in executing the steps of the processes, methods, functionality, and techniques described herein, and to control various communications, decisions, programs, content, listings, services, interfaces, logging, reporting, etc. Further, the one or more processors 128 may access the memory devices 122, which may store instructions 126, code and the like that are executed by the processors 128 to implement intended functionality.

The memory devices 122 typically include one or more processor-readable and/or computer-readable media accessed by at least the processors 128 and may include volatile and/or nonvolatile media, such as RAM, ROM, EEPROM, flash memory and/or other memory technology. Further, the memory devices 122 are shown as internal to the controller 110; however, the memory devices 122 may be internal, external or a combination of internal and external memory. Similarly, some or all of the memory devices 122 can be internal, external or a combination of internal and external memory of the processors 128. The memory devices 122 may be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network.

The memory devices 122 may store data 124 such as code, software, executables, scripts, data, content, lists, programming, programs, log or history data, engine information, component information, and the like. While FIG. 1 illustrates the various components being coupled together via a bus, it is understood that the various components may actually be coupled to the controller 110 and/or one or more other components directly. The memory devices 122 stores the operational code or set of instructions 126 that is executed by the controller 110 and/or processor 128 to implement the functionality of the system 100 or parts thereof. In some embodiments, the memory devices 122 may also store some or all of the data 124 that may be needed to operate the degausser apparatus 101.

The I/O devices 130 may be any relevant port or combinations of ports, such as but not limited to USB, Ethernet, or other such ports. The I/O devices 130 may be configured to allow wired and/or wireless communication coupling to external components. For example, the I/O devices 130 may provide wired communication and/or wireless communication (e.g., Wi-Fi, Bluetooth, cellular, RF, and/or other such wireless communication), and in some instances may include any suitable wired and/or wireless interfacing device, circuit and/or connecting device, such as but not limited to one or more transmitters, receivers, transceivers, or combination of two or more of such devices.

The user interface 132 may be used to control one or more components of the system 100. The system 100 and various components thereof may be operated and controlled via the user interface 132. The user interface 132 may be used for user input and/or output display. For example, the user interface 132 may include any known input devices, such as one or more buttons, knobs, selectors, switches, keys, touch input surfaces, audio input, displays, etc. Additionally, the user interface 132 may include one or more output display devices, such as lights, visual indicators, display screens, etc., to convey information to a user, such as but not limited to communication information, status information, order information, delivery information, notifications, errors, conditions, and/or other such information. Similarly, the user interface 132 in some embodiments may include audio systems that can receive audio commands or requests verbally issued by a user, and/or output audio content, alerts, and the like.

In some embodiments, the controller 110 may be represented equally as either an integrated application specific integrated circuit (ASIC) or similarly a field programmable gate array (FPGA), allowing the clock generation, timing, communication, and degaussing operation control circuitry to be embedded into a single chip. Further, the control could be implemented in a synchronous circuit and accomplish the same functionality. Additionally, the system could be fully represented as a standalone analog circuit, where various physical processes correspond to the digital timing approach. This could be accomplished using charge integrators, dynamic charge and discharge of timing capacitors using MOSFETs in the triode region, or any other combination of circuits.

The oscillator 112 is configured to output pulses at a predetermined frequency to track time for the system 100. The oscillator 112 quantizes time for processing in the system 100. For example, the oscillator 112 may accrue or generate a number of pulses or clock counts to track time for the system 100. As illustrated, the oscillator 112 is shown separate from the controller 110, however, it is contemplated that the oscillator 112 may be incorporated in the controller 110. In some embodiments, the oscillator 112 is a high speed, low drift oscillator. In some approaches, the controller 110 may track a number of oscillator pulses that have elapsed between interruptions in the first set of position detectors 102A and/or the second set of position detectors 102B.

The database(s) 114 can store any data that is used to operate the degausser apparatus 101. In some embodiments, the database(s) 114 store data that is received from the degausser apparatus 101, for example from sensors such as position detectors that are part of the degausser apparatus 101.

One or more components of the system 100 including the degausser apparatus 101, the destruction device 106, the sorting system 108, the controller 110, the oscillator, and the database(s) 114 may communicate information to or from one another over the network 140. The network 150 may be any suitable communication network such as, for example, LAN, WAN, Internet, cellular, Wi-Fi, and other such communication networks or combinations of two or more of such networks. The network 150 may also include wired communications.

In some alternative embodiments, instead of and/or in addition to the position detectors 102, the system 100 may include an inductance sensing circuit 152 that is configured to monitor an inductance of the degausser apparatus 101 to accomplish the auto discharge functionality. For example, the system 100, may include inductive sensors in the translation mechanism 109 or within the erasure device 103 (e.g., a bulk eraser head bobbin) to detect when a metal bodied media had passed over it. The inductance sensing circuit 152 may be configured to monitor an inductance of a magnetic field generator of the degausser apparatus 101. The controller 110 may be communicatively coupled to the inductance sensing circuit 152. In some aspects, the controller 110 is configured to receive data that includes the inductance of the magnetic field from the inductance sensing circuit 152. The data on the inductance of the magnetic field is indicative of a position of the magnetic media within a magnetized volume of the erasure device (e.g., a magnetic field generator). The controller 110, may be further configured to control a timing of the degaussing operation based on the data on the inductance of the magnetic field. For example, the controller 110 may be configured to initiate the degaussing operation upon detecting a peak in the inductance.

In some embodiments, a secondary copper wrap may be disposed on a coil of the degausser apparatus 101, which would be separate from the high voltage circuitry required for the degaussing operation. This secondary wrap may act as the inductance sensing element for the magnetic volume of the degaussing apparatus, potentially reducing the space required to accomplish the same. These same ideas could be extended to the capacitance of the system.

FIG. 2 shows an exemplary laser gate 200. One or more laser gates 200 may be employed in the systems and apparatus for electromagnetic erasure of magnetic storage media that are described herein. In some embodiments, the laser gate 200 is used as the position detector 102 in the degausser apparatus 101 of FIG. 1. The laser gate includes a transmitter 202 and a receiver or photodetector 204. The transmitter 202 sends a photon beam 206 across a physical space. The photodetector 204 detects the successful transmission of photons (e.g., the photon beam 206) from the transmitter 202 across the physical space. The photon beam 206 has a given field of view. The field of view of the photon beam refers to the spatial extent over which the beam can be detected or observed. In this manner, the field of view may be the area within which the photodetector 204 can detect photons in the photon beam 206.

In some embodiments, the laser gate 200 and, in particular, the photodetector 204 is electrically interfaced to a controller, such as the controller 110 of FIG. 1. The controller can monitor the photodetector 204 to detect when the photon beam 206 is interrupted, indicating when a piece of magnetic media is passing through the laser gate 200. Data received from the photodetector 204 can then be used to control the timing for a degaussing operation performed by the degausser apparatus.

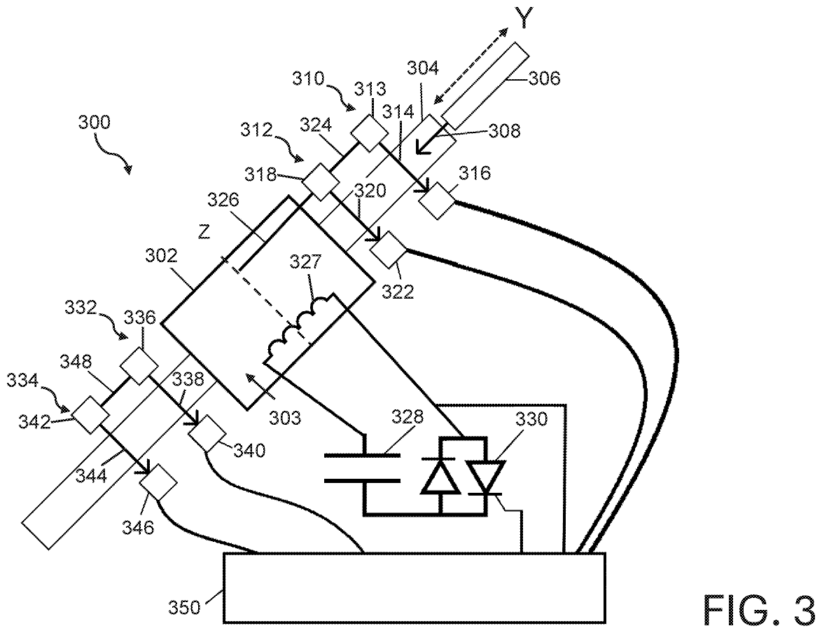

FIG. 3 shows an exemplary degausser apparatus 300. In some embodiments, the degausser apparatus 300 can be employed as the degausser apparatus 101 in the system 100 of FIG. 1. The degausser apparatus 300 generally includes an erasure device 302 for erasing a media 306, a chute 304 for transporting the media 306 through the erasure device 302, a first set of laser gates 310, 312 disposed at inlet of the erasure device 302, and a second set of laser gates 332, 334 disposed at the outlet of the erasure device 302. The first set of laser gates 310, 312 includes a first laser gate 310 and a second laser gate 312. The second set of laser gates 332, 334 includes a third laser gate 332 and a fourth laser gate 334. The first set of laser gates 310, 312 and the second set of laser gates 332, 334 are communicatively coupled to a controller 350. The controller 350 controls the timing of a degaussing operation that performed by the erasure device 302 to erase the media 306.

The degausser apparatus 300 can be used to erase the media 306 and, in some aspects, can perform a permanent erasure of the media 306. In some embodiments, the media 306 is a magnetic media. Examples of the types of media 306 that can be erased using the degausser apparatus include but are not limited to hard disk drives, LTO tapes, etc. In some examples, the media length Y is about 4″ (2.5″ HDD form factor) or about 5.75″ (3.5″ HDD form factor).

As illustrated, the erasure device 302 is a magnetic field generator. The erasure device 302 is configured to erase the media 306 as it passes through the chute 304. The erasure device 302 may be any suitable erasure device and, in some aspects, is an energy storage device that is coupled to an inductor of specific properties conducive to erasing a particular medium, the inductor coupled to a discharge device, such as a silicon-controlled rectifier or high-power relays. In some embodiments, the erasure device 302 is a magnetic field generator that is configured to perform a degaussing operation. As illustrated, the erasure device 302 includes a cavity 303. A degaussing coil 327 is disposed in the cavity 303. The degaussing coil 327 is operatively coupled to capacitors 328 and a discharge device 330. The capacitors 328 hold charge that induces a magnetic field in the cavity 303 to erase the media 306. The discharge device 330 couples the capacitors 328 to a ground connection through the erasure device and thereby induces a magnetic field. The capacitors 328, discharge device 330, and degaussing coil 327 collectively may be referred to herein the magnetic field generator. Though, it is to be understood that this is just one exemplary embodiment of a magnetic field generator and any alternative magnetic field generator can be employed in the degausser apparatus 300.

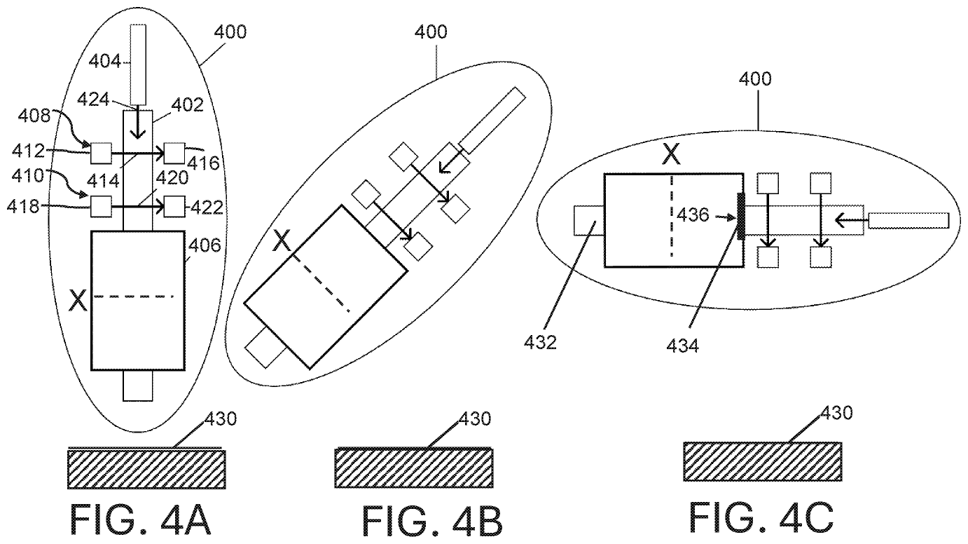

The chute 304 is configured to transport or convey the media 306 through degausser apparatus 300 and, in particular, through the erasure device 302. The chute 304 is an inclined channel, for example, in the form of trough, tube, shaft, or slide. However, any suitable translation mechanism, for example motorized mechanisms such as belt conveyors, slat conveyors, roller conveyors, or pneumatic conveyors, can be used to transport the media 306 through the degausser apparatus 300. In some embodiments, the chute 304 is disposed at an incline or angle relative to the ground. Exemplary orientations of the chute relative to the ground are illustrated in FIGS. 4A, 4B, and 4C.

The first set of laser gates 310, 312 are positioned at an inlet of the erasure device 302. That is, the first set of laser gates 310, 312 are disposed upstream of the erasure device 302. The first laser gate 310 is disposed a first distance 324 from the second laser gate 312. The first laser gate 310 comprises a first transmitter 313 that sends a first photon beam 314 to a first photodetector 316. The first photodetector 316 is configured to detect the first photon beam 314 from the first transmitter 313 and convert the light signal to an electrical signal. The first photodetector 316 is electrically interfaced with the controller 350. The second laser gate 312 is disposed a second distance 326 from a centerline Z from the erasure device 302. The second laser gate 312 comprises a second transmitter 318 that sends a second photon beam 320 to a second photodetector 322. The second photodetector 322 is electrically interfaced with the controller 350. The second photodetector 322 is electrically interfaced with the controller 350 and is configured to receive data from the second photodetector 322. The data is indicative of the presence of the media 306 relative to the second laser gate 312.

The second set of laser gates 332, 334 are positioned at an outlet or exit of the erasure device 302. That is, the second set of laser gates 332, 334 are disposed downstream of the erasure device 302. The second set of laser gates 332, 334 may be disposed a known distance from the erasure device 302. The third laser gate 332 comprises a third transmitter 336 that sends a third photon beam 338 to a third photodetector 340. The fourth laser gate 334 comprises a fourth transmitter 342 that sends a fourth photon beam 344 to a fourth photodetector 346. The third photodetector 340 and the fourth photodetector 346 are electrically interfaced with the controller 350. As such, the controller 350 is configured to receive data from the third photodetector 340 and the fourth photodetector 346. The data from the third photodetector 340 and the fourth photodetector 346 is indicative of the presence of the media 306 relative to the third laser gate 332 and the fourth laser gate 334, respectively.

The controller 350 is configured to monitor or receive data from the first photodetector 316 and the second photodetector 322. The data is indicative of the position or presence of the media 306 relative to the first laser gate 310 and the second laser gate 312, respectively. Because the first distance 324 and the second distance 326 are known, the data from the photodetectors 316, 322 is also indicative of the position or presence of the media 306 relative to the erasure device 302 (e.g., relative to the centerline X of the erasure device 302). In some embodiments, the controller is also configured to determine one or more characteristics of the media based on the data from the photodetectors 316, 322, the first distance 324, and/or the second distance 326. Characteristics of the media that can be determined by the controller may include at least one of a velocity of the media 306, the length Y of the media 306, or an acceleration of the media 306.

The controller 350 is operatively coupled to the erasure device 302. The controller 350 is configured to control a timing of a degaussing operation performed by the erasure device 302 based on the data from the photodetectors 316, 322 and/or the characteristics of the media 306. In some embodiments, the controller 350 includes an oscillator, such as the oscillator 112 described with reference to FIG. 1. The oscillator may be configured to quantize time for the degausser apparatus 300 using a number of oscillator pulses. In some embodiments, the controller 350 is configured to a number of oscillator pulses to determine characteristics of the media 306, such as an acceleration and/or a velocity of the media 306.

In operation, the media 306 enters the chute 304 and passes through the chute 304 towards the erasure device 302. The media 306 travels through the first laser gate 310 and, in doing so, interrupts the first photon beam 314. The interruption to the first photon beam 314 causes a change in the electrical signal from the first photodetector 316. The controller 350 can therefore detect the interruption of the first photon beam 314 by the media 306 and process data on the interruption of the first photon beam 314 to determine the presence and/or position of the media 306 relative to the erasure device 302. Further, the controller 350 can detect a first exit of the media 306 from the first photon beam 314, for example, based on when the interruption to the first photon beam 314 ends (e.g., when the media clears the first photon beam 314).

Similarly, the media 306 travels through the second laser gate 312 and, in doing so, interrupts the second photon beam 320. The interruption to the second photon beam 320 causes a change in the electrical signal from the second photodetector 322. The controller 350 can therefore detect the interruption of the second photon beam 320 by the media 306 and process data on the interruption of the second photon beam 320 to determine the presence and/or position of the media 306 relative to the erasure device 302. Further, the controller 350 can detect a second exit of the media 306 from the second photon beam 320, for example, based on when the interruption to the second photon beam 320 ends (e.g., when the media clears the second photon beam 320).

The controller 350 may be configured determine a number of oscillator pulses that have passed during interruption of the first photon beam 314. Based at least in part on the number of oscillator pulses to clear the first laser gate 310, the controller 350 can determine a velocity of the media as it travels through the first laser gate 310. Using the number of oscillator pulses to clear the first laser gate 310 and the velocity of the media 306 when passing the first laser gate 310, the length Y of the media can be determined or calculated by the controller 350.

Similarly, the controller 350 may be configured to determine a number of oscillator pulses that have passed during interruption of the second photon beam 320. Based at least in part on the number of oscillator pulses to clear the second laser gate 312, the controller 350 can determine a velocity of the media as it travels through the second laser gate 312. Using the number of oscillator pulses to clear the second laser gate 312 and the velocity of the media 306 when passing the second laser gate 312, the length Y of the media can be determined or calculated by the controller 350

The controller 350 may be configured to initiate a degaussing operation, for example, by controlling the capacitive discharge of the erasure device 302. In some approaches, the controller 350 is configured to control the capacitive discharge of an electromagnet of the erasure device 302 such that the capacitor discharge occurs when the media is at or adjacent to the centerline Z in the cavity 303.

In some embodiments, the controller 350 is configured to determine an exit velocity of the media 306, for example, after the degaussing operation has been performed on the media 306, based on data received from the second set of laser gates 332, 334. The controller 350 may be further configured to calibrate a timing of the degaussing operating based on the exit velocity. Deviations due to thermal effects, age, or other known electrical change over time, can cause the media to be offset from the centerline Z of the erasure device 302. A target location for erasure that imparts the lowest kinetic energy to the media 306 is at or adjacent to the centerline Z of the erasure device 302. However, when the media 306 is offset, the magnetic impulse applied during the degaussing operation may impart force on the media 306. For example, an offset of about two centimeters with a 3 Tesla magnetic impulse can impart over 250 Newtons of force. Thus, drift or offset that occurs in the degausser apparatus 300 over time, can lead to a gradual increase in the amount of force imparted on the media 306. This force can be detected by the second set of laser gates 332, 334. In some approaches, the controller 350 is calibrated using an offset to the timing of the degaussing operation. Such calibration may protect an operator and/or equipment downstream of the erasure device 302 from damage.

In some embodiments, the first set of laser gates 310, 312 can be placed in such a way that they operate within the erasure device 302. The photon beams of the first laser gate 310 and the second laser gate 312 may be oriented to point into a volume of the cavity 303. In another example, the photon beams may be within the volume of the cavity 303, to detect when the media is in the preferable placement for degaussing.

Additionally, in some embodiments, the first set of laser gates 310, 312 are simplified to a single position detector, for example, if the length of the media is known in advance.

FIGS. 4A, 4B, and 4C shows various orientations for a degausser apparatus 400, in accordance with these teachings. The degausser apparatus 400 includes an erasure device 406. In some examples, the erasure device 406 is a magnetic field generator. The degausser apparatus 400 includes a chute 402 that translates a media 404, such as a magnetic media, through the degausser apparatus 400 and, in particular, through the erasure device 406. While the degausser apparatus 400 includes a chute, it is contemplated that any translation mechanism can be used. The degausser apparatus 400 further includes first laser gate 408 and a second laser gate 410. The first laser gate 408 comprises a first transmitter 412 that sends a first photon beam 414 to a first photodetector 416. The second laser gate 410 comprises a second transmitter 418 that sends a second photon beam 420 to a second photodetector 422. The first laser gate 408 and the second laser gate 410 are positioned at an inlet of the erasure device 406. Line 424 shows the direction of travel of the media 404 through the degausser apparatus 400. The orientations of the degausser apparatus 400 can be employed in the system 100 of FIG. 1.

In FIG. 4A, the degausser apparatus 400 is oriented at an angle of about 90 degrees relative to the floor 430. Thus, the degausser apparatus 400 is oriented perpendicular or approximately perpendicular to the floor 430. So oriented, the media 404 is able to freely fall into the erasure device 406. When the degausser apparatus 400 is oriented at an angle of about 90 degrees, the degausser apparatus 400 may be configured to perform a degaussing operation once the media 404 has passed a centerline X of the erasure device 406. In this manner, energy imparted on the media 404 by the erasure device 406 may counteract gravity. In one example, a controller such as the controller 110 of FIG. 1 may be configured to cause the erasure device 406 of the degausser apparatus 400 to perform the degaussing operation once the media 404 has passed the centerline X. The controller may operate the erasure device 406 based on data received from the laser gates 408, 410.

In FIG. 4B, the degausser apparatus 400 is oriented at an angle of between about 10 degrees and about 90 degrees relative to the floor 430. In some embodiments, the degausser apparatus is oriented at an angle of between about 20 degrees and about 90 degrees, about 25 degrees and about 75 degrees, between about 35 degrees and about 65 degrees, or, in some aspects, between about 45 degrees and about 55 degrees relative to the floor 430. So oriented, the force of gravity moves the media 404 through into the erasure device 406. When the degausser apparatus 400 is oriented in this manner, the degausser apparatus 400 may be configured to perform a degaussing operation once the media 404 has passed a centerline X of the erasure device 406. In this manner, energy imparted on the media 404 by the erasure device 406 may counteract gravity. In some embodiments, a controller such as the controller 110 of FIG. 1 may be configured to cause the erasure device 406 of the degausser apparatus 400 to perform the degaussing operation once the media 404 has passed the centerline X. The controller may operate the erasure device 406 based on data received from the laser gates 408, 410.

In FIG. 4C, the degausser apparatus 400 is oriented at an angle of about 0 degrees relative to the floor 430. Thus, the degausser apparatus 400 is oriented parallel or approximately parallel to the floor 430. In some embodiments, the degausser apparatus 400 is oriented at a small but non-zero angle relative to the floor 430, for example, at an angle of less than about 5 degrees relative to the floor. In some embodiments, when the degausser apparatus 400 is oriented in this manner, the degaussing operation is performed when the media 404 is offset from the centerline X of the erasure device 406 to maximize the amount of force imparted on the media 404. Performing the degaussing operation exposes the media 404 to an erasure magnetic field and may also translate the media 404 to an exit slide or slot 432, where the media 404 exits the erasure device 406 and, in some aspects, is be translated into a downstream device.

Referring to FIG. 4C, in some embodiments the degausser apparatus 400 is configured for manual loading. In manual loading, an operator places the media 404 into the chute 402 or into an inlet opening to the erasure device 406. The erasure device 406 may include an entry gate 434 coupled to an entry slot 436. The entry gate 434 that can be opened to allow the erasure device 406 to receive the media 404 and closed to prevent the media 404 from being ejected from the erasure device 406. The entry gate 434 may be an electrically operated gate. When the degausser apparatus 400 is configured for manual loading, the degausser apparatus 400 may not include the first laser gate 408 and/or the second laser gate 410. In some embodiments, a controller such as the controller 110 of FIG. 1 may be configured to control the entry gate 434 to regulate the introduction of the media into the erasure device 406.

Still referring to FIG. 4C, in other embodiments, the degausser apparatus 400 is configured for combined manual and automatic loading. For example, the chute 402 can include a belt that translates the media 404 through the chute 402 and into the erasure device 406. In some examples, an operator can place the media 404 on the belt. The belt may be non-cleated belt so that the media 404 is free to move along the belt when a force is imparted on the media. The magnetic field pulse can pull on and damage the belt over time. A non-cleated belt may help to reduce such damage. The belt can also degrade the magnetic field depending on the material. For combined manual and automatic loading. The degausser apparatus 400 may include one or more of the first laser gate 408 and the second laser gate 410. For example, the first laser gate 408 and/or the second laser gate 410 could detect the entry of the media 404 into the erasure device 406 and initiate the degaussing operation, translating the media 404 in the same way as previously described. In some embodiments, a controller such as the controller 110 of FIG. 1 may be configured to cause the erasure device 406 of the degausser apparatus 400 to perform the degaussing operation based on data received from the laser gates 408, 410.

FIG. 5 shows a method 500 for electromagnetic erasure of magnetic media using a magnetic field generator. The method 500 or portions thereof can be implemented by the controller 110 of FIG. 1 and/or by the controller 350 of FIG. 3. That is the controller 110 and/or the controller 350 may be configured to perform the method 500 or portions thereof.

In the method 500, the controller receives, at 502, first data from a first set of position detectors. The first data includes data that is indicative of the presence of a magnetic media relative to the first set of position detectors. In some aspects, the first data includes data that is indicative of the presence of the magnetic media relative to the magnetic field generator. For example, when the distance from the first set of position detectors is known, detecting that the media relative to the position detector(s) also indicates how far the media is from the magnetic field generator.

The first set of position detectors is disposed at or adjacent to an inlet of a magnetic field generator. The first set of position detectors may be disposed a known distance from the inlet of the magnetic field generator. The magnetic field generator is configured to perform a degaussing operation to erase data from a magnetic media. Though the method 500 is described with reference to a magnetic field generator, it is contemplated that any suitable erasure device can be used. In some embodiments, the erasure device 302 of FIG. 3 is employed as the magnetic field generator.

In one embodiment, the first set of position detectors includes a first laser gate and a second laser gate. The first laser gate is disposed a first distance from the second laser gate. The second laser gate is disposed a second distance from the magnetic field generator. The first laser gate includes a first photodetector configured to detect a first photon beam from a first transmitter. The second laser gate includes a second photodetector configured to detect a second photon beam from a second transmitter. In some embodiments, the position detectors are the laser gate 200 of FIG. 2 or the first set of laser gates 310, 312 of FIG. 3.

At 504, the controller may receive second data from an oscillator. The oscillator is configured to output pulses at a predetermined frequency to track time, for example as a number of clocks or pulses. The oscillator can be incorporated in or otherwise in communication with the controller and, in some embodiments, is the oscillator 112 of FIG. 1. In some embodiments, the second data is a number of oscillator clocks or pulses.

At 506, the controller determines one or more characteristics of the magnetic media based on at least one of the first data or the second data. The characteristic(s) of the magnetic media can be any characteristic of the magnetic media that is useful to determining or defining the position or movement of the magnetic media in the degausser apparatus. In some approaches, the characteristic(s) of the magnetic media includes at least one of a position, velocity, size, or acceleration of the magnetic media. The size of the magnetic media can be a length or any other dimension of the magnetic media.

In some embodiments, the controller determines the characteristic(s) based on interruptions in the photon beams of the first and second laser gates and a number of oscillator pulses between interruptions. For example, the controller may detect a first interruption of the first photon beam of the first laser gate and to detect a second interruption of the second photon beam of the second laser gate. The controller may also determine a number of oscillator pulses between the first interruption and the second interruption; and determine a first or entry velocity of the magnetic media based on the number of oscillator pulses between the first interruption and the second interruption, the first distance, and the second distance. Because the photodetectors are arranged with one set being placed a fixed distance ahead of another set, the number of oscillator pulses that have passed between interruptions allows the calculation of the velocity of the media while passing the photodetector array. Additionally, when the media clears the photodetector, another pulse is generated, which is used to determine an exit velocity when the magnetic media exits the photodetector array.

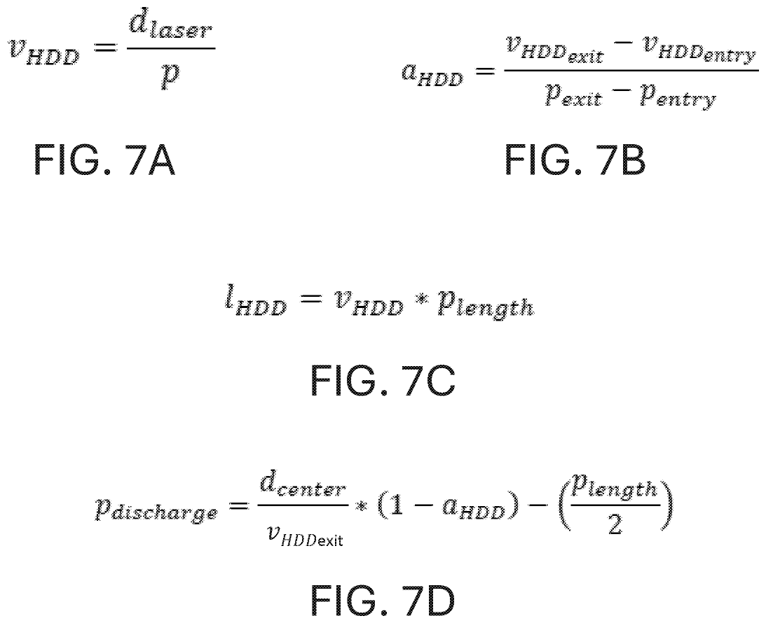

In some embodiments, the controller determines an entry velocity and an exit velocity of the magnetic media based on data related to when the magnetic media interrupts (e.g., enters) or clears (e.g, exits) the laser gates. The entry velocity is calculated or determined using the interruption of successive laser gates in the first set of laser gates. The exit velocity is calculated using the clearing of successive laser gates in the first set of laser gates. Turning briefly to FIG. 7A, an exemplary equation for velocity (v_{HDD}) of the magnetic media is shown. The equation of FIG. 7A can be used to calculate both the entry velocity and exit velocity of the media through the first set of laser gates. In the equation of FIG. 7A, the velocity (v_{HDD}) is determined based on the distance to the magnetic field generator (dₗₐₛₑᵣ) and the number of oscillator pulses that have passed between interruptions of the first laser gate and the second laser gate (p). The calculation of entry velocity and exit velocity for a set of laser gates, such as those positioned at the entry of the magnetic field generator, may follow the same equation. The only difference is whether the photodetector is interrupted (e.g., for entry velocity) or cleared (e.g., for exit velocity), indicating media is present or media is no longer present, respectively.

In some embodiments, the controller also determines an acceleration of the magnetic media based on the entry velocity and the exit velocity. The acceleration is calculated by subtracting the velocity at the first gate (e.g., the entry velocity) from the velocity at the second gate (e.g., the exit velocity) and dividing by the pulse count when the entry velocity is calculated subtracted from the pulse count when the exit velocity is calculated. Turning briefly to FIG. 7B, an exemplary equation for the acceleration (a_{HDD}) of the magnetic media is shown. In the equation of FIG. 7B, the acceleration (a_{HDD}) of the magnetic media is determined based on the entry velocity (v_{HDDentry}) of the magnetic media, the exit velocity (v_{HDDexit}) of the magnetic media, the pulse count of the oscillator when the entry velocity is calculated (p_{entry}), and the pulse count of the oscillator when the exit velocity is calculated (pₑₓᵢₜ).

In some embodiments, the controller determines a length of the magnetic media based on the number of oscillator pulses during interruption of a laser gate and the velocity of the magnetic media passing through the laser gate. For example, the controller may be configured determine a number of oscillator pulses that passed between the interruption and clearing of the photodetector (p_{length}) of the laser gate. Turning briefly to FIG. 7C, an exemplary equation for the length (l_{HDD}) of the magnetic media is shown. The equation of FIG. 7C determines the length (l_{HDD}) of the magnetic media based on the velocity (v_{HDD}) and the number of oscillator pulses that passed between the interruption and clearing of the photodetector (p_{length}).

In some embodiments, the controller determines a discharge delay for the magnetic field generator, which dictates the timing of the degaussing operation. The discharge delay is the number of cycles or pulses to wait before discharging the magnetic field generator to perform the degaussing operation. The discharge delay dictates the amount of time that the controller waits after the media exits the second set of laser gates before performing the discharge operation. For example, the location of the media within the degausser apparatus can be determined based on the characteristic(s) of the magnetic media (e.g., velocity, acceleration, length). The controller may determine the discharge delay, based on the velocity, acceleration, and/or the distance from the exit of the laser gates to the center of the electromagnet in the magnetic field generator to control the timing for performing the discharge operation.

One challenge that occurs when using a degausser apparatus to erase media is a lack of prior knowledge on what is being fed into the degausser. In the method 500, prior knowledge on the media is not required. The amount of time that passes for the magnetic media to be centrally located in the cavity of the degausser is determined by a discharge delay formula. Once that calculated amount of time (e.g., the discharge delay) passes, the degaussing operation is initiated. The discharge delay is calculated or determined after the magnetic media exits the first set of laser gates.

Turning briefly to FIG. 7D, an exemplary equation that can be used to determine the discharge delay is shown. In the equation of FIG. 7D, the discharge delay is determined based on a distance to a centerline of the magnetic field generator (d_{center}), the exit velocity (v_{HDDexit}) of the magnetic media, the acceleration (a_{HDD}) of the magnetic media, and the number of oscillator pulses that passed between the interruption and clearing of the photodetector (p_{length}). By averaging the calculated lengths (as determined at entry and exit of each unit in the photodetector array), an accurate representation of the length of the media can be calculated. The final velocity of the media can be used to calculate the number of pulses until the media is centrally located within the bulk erasure head and the acceleration used as a degradation factor, reducing the number of pulses proportionate to the increase in speed. In some embodiments, the (1−a_{HDD}) term is removed from the equation for the discharge delay shown in FIG. 7D.

In some embodiments, at 510, the controller receives third data from a second set of position detectors. The second set of position detectors are disposed at or adjacent to an outlet of the magnetic field generator. For example, the second set of position detectors may be disposed a known distance from an outlet of the magnetic field generator. The third data includes data that is indicative of the presence of a magnetic media relative to the second set of position detectors. In some aspects, the third data includes data that is indicative of the presence of the magnetic media relative to the magnetic field generator.

In some embodiments, the second set of position detectors includes a second set of laser gates. The second set of laser gates may include a third laser gate and a fourth laser gate. The third laser gate and the fourth laser gate are disposed known distances from the magnetic field generator. The third laser gate including a third photodetector configured to detect a third photon beam from a third transmitter. The fourth laser gate includes a fourth photodetector configured to detect a fourth photon beam from a fourth transmitter. In some embodiments, the position detectors include the laser gate 200 of FIG. 2 and/or the second set of laser gates 332, 334 of FIG. 3.

In some embodiments, at 512, the controller determines one or more outlet characteristics of the magnetic media based on the third data. The outlet characteristic may define a property of the magnetic media after the degaussing operation has been performed to erase the magnetic media. The outlet characteristic(s) can include at least one of an outlet velocity or an outlet acceleration of the media. The out velocity refers to a velocity of the magnetic media after the degaussing operation has been performed, for example, subjecting the magnetic media to a capacity discharge by the magnetic field generator. The outlet acceleration refers to an acceleration of the magnetic media after the degaussing operation has been performed, for example, subjecting the magnetic media to a capacity discharge by the magnetic field generator.

In some embodiments, at 514, the controller calibrates the timing of the degaussing operation based on the outlet characteristic(s) of the magnetic media. For example, the controller may then calibrate the timing of the degaussing operation by determining a number of counts or pulses of the oscillator by which to offset the degaussing operation based on the outlet characteristic(s) of the magnetic media. In one example, the controller calibrates the timing by offsetting a timing for performing the degaussing operation by number of oscillator counts or pulses.

FIG. 6 shows another exemplary method 600 for electromagnetic erasure of magnetic media. The method 600 or portions thereof can be implemented by the controller 110 of FIG. 1 and/or by the controller 350 of FIG. 3. That is, the controller 110 and/or the controller 350 may be configured to execute or cause the method 600 or portions thereof to be performed. In some embodiments, the method 600 is used to operate a degausser apparatus, such as the degausser apparatus 300 of FIG. 3. The degausser apparatus includes a first set of laser gates disposed at the inlet of the degausser apparatus. The first set of laser gates includes a first laser gate (e.g., an entry laser gate) such as the first laser gate 310. The first set of laser gates also includes a second laser gate (e.g., an exit laser gate) such as the second laser gate 312.

In the method 600, a controller associated with the degausser apparatus may determine or calculate various variables associated with operation of the degausser apparatus. The controller may further include or be in communication with an oscillator, such as the oscillator 112 of FIG. 1, to determine one or more of the process variables. One or more of the process variables can be employed by the controller to determine the timing for a capacitive discharge by a magnetic field generator (e.g., an erasure device). In some approaches, the capacitive discharge is the degaussing operation referred to herein. The capacitive discharge generates a magnetic field sufficient to erase a magnetic media that passes through the degausser apparatus.

In some embodiments, the process variables determined by the controller include one or more of: a clock count (e.g., a number of oscillator pulses); an first velocity of the magnetic media (e.g., an entry velocity); a first media length for the magnetic media (e.g., an entry media length), a second velocity of the magnetic media (e.g., an exit velocity), a second media length of the magnetic media (e.g., an exit media length), an average media length of the magnetic media, an acceleration of the magnetic media, and a discharge delay for the degausser apparatus.

In some embodiments, the discharge delay is represented as a number of counts or pulses of an oscillator. The discharge delay is a pre-determined amount of time that the controller waits before performing the degaussing operation (discharging the degausser apparatus) after the magnetic media exits the first set of laser gates. Because the apparatus has calculated the speed, acceleration, and media length relative to the oscillator frequency (or pulse speed), then the number of pulses for the media to move the further distance (exit of first set of laser gates to center of the coil, X) is easily calculated. In some embodiments, the pre-determined amount of time for the discharged delay is determined as described in the following method 600. The discharge delay is measured from a time after the magnetic media exits the first set of laser gates, that is, after the magnetic media exits the second laser gate. For example, after the magnetic media exits the second laser gate, the controller waits for the discharge delay to pass and, after discharge delay passes the controller causes the degaussing operation to be performed. The discharge delay may be determined such that the magnetic media is centrally located within the cavity of the magnetic media generator when the degaussing operation is performed. However, it is contemplated that the discharge delay can be adjusted to achieve positioning within the cavity when the discharging operation is performed.

The method 600 starts, at 601, with the controller setting the process variables to zero. At 602, the controller determines if the magnetic media has entered or interrupted the photon beam of the first or entry laser gate in the first set of laser gates. For example, the controller may detect a second entry of the magnetic media into the first laser gate. If the photon beam of the first laser gate has not been interrupted, at 603, the controller waits until the photon beam of the first laser gate is interrupted. If the photon beam of the first laser gate has been interrupted, at 604, the controller detects that the photon beam of the first laser gate has been interrupted. At 605, the controller resets the clock count to begin counting clock cycles or pulses.

At 606, the controller determines if the magnetic media has entered and interrupted the photon beam of the second or exit laser gate into the first set of laser gates. For example, the controller may detect a second entry of the magnetic media in the second laser gate. If the photon beam of the second laser gate has not been interrupted, at 607, the controller waits until the photon beam of the second laser gate is interrupted. If the photon beam of the second laser gate has been interrupted, at 608, the controller detects that the photon beam of the second gate has been interrupted. At 609, the controller uses the number of clocks or pulses that have passed between interruption of the second laser gate and the first laser gate (p or p_{entry}) to determine a first or entry velocity (v_{HDD} or v_{HDDentry}) of the magnetic media. The controller may also use a known distance (dₗₐₛₑᵣ) from the first laser gate to the second laser gate to determine the entry velocity (v_{HDDentry}). In some embodiments, the controller uses the equation of FIG. 7A to determine the entry velocity (v_{HDDentry}) of the magnetic media.

At 610, the controller determines if the media has exited the first laser gate. For example, the controller may detect a first exit of the media from the first laser gate. If the magnetic media has not exited the first laser gate, at 611 the controller waits until the photon beam of the first laser gate is no longer interrupted. If the magnetic media has exited the first laser gate, at 612 the controller detects that the photon beam of the first laser gate is no longer interrupted. At 613, the controller determines a number of clocks or pulses that were counted while the photon beam of the first laser gate was interrupted (p_{length} or p_{length-entry}) to determine an entry length (l_{HDD} or l_{HDD-entry}) for the magnetic media. In some embodiments, the controller uses the equation of FIG. 7C to determine the entry length (l_{HDD-entry}), for example, using the entry velocity (v_{HDDentry}).

At 614, the controller determines if the media has exited the second laser gate. For example, the controller may detect a second exit of the media from the second laser gate. If the magnetic media has not exited the second laser gate, at 615 the controller waits until the photon beam of the second laser gate is no longer interrupted. If the magnetic media has exited the second laser gate, at 616, the controller detects that the photon beam of the second laser gate is no longer interrupted. At 617, the controller uses the number of clocks or pulses that were counted while the second laser gate was interrupted (p_{length} or p_{length-exit}) determine or calculate an exit media length (l_{HDD} or l_{HDD-exit}) for the magnetic media. The controller may use both media lengths (e.g., the entry media length (l_{HDD-entry}) determined at blocks 613, the second media length (l_{HDD-exit}) determined at block 617) to determine or calculate the average media length. In some embodiments, the controller uses the equation of FIG. 7C to determine the exit media length (l_{HDD-exit}), for example, using the exit velocity (l_{HDD-exit}).

At 617, the controller may also use the number of clocks or pulses counted between an exit of the magnetic media from first laser gate and the exit of the magnetic media from the second laser gate (p or pₑₓᵢₜ) to determine or calculate the second or exit velocity (v_{HDDexit}) of the magnetic media. In some embodiments, the controller uses the equation of FIG. 7C to determine the exit media length (l_{HDD-exit}), for example, using the exit velocity (v_{HDDexit}).

At 618, the controller uses the entry velocity of the magnetic media and the exit velocity of the magnetic media to determine or calculate the acceleration of the magnetic media. In some embodiments, the controller uses the equation of FIG. 7B to determine the acceleration (a_{HDD}) of the magnetic media.

At 618, the controller then also determines or calculates the discharge delay for performing the degaussing operation using the acceleration, a number of clocks or pulses that represents the length of the magnetic media, and the exit velocity of the magnetic media. The discharge delay may be represented as a number of clocks or pulses by the oscillator. In some embodiments, the controller uses the equation of FIG. 7D to determine the discharge delay (p_{discharge}). The equation of FIG. 7D uses a distance from the second laser gate to the centerline of the magnetic field generator (d_{center}) to determine the discharge delay. As noted above, the discharge delay is measured from when the magnetic media exits the second laser gate. This is why half of the length of the magnetic media is subtracted in FIG. 7D. Subtracting half of the length helps to prevent the degasser apparatus from discharging when a rear face of the magnetic media is positioned centrally in the cavity of the magnetic field generator.

At 619, the controller determines whether the discharge delay (e.g., the number of clock counts for the discharge delay) has passed. If the number of clock counts for the discharge delay has not passed, at 620, the controller waits until the number of clock counts has passed. At 621, the controller determines that the number of clock counts for the discharge delay has passed. At 622, the controller operates the degausser to perform a degaussing operation to erase the magnetic media. For example, to initiate the degaussing operation, the controller may engage the discharge electronics of the degausser apparatus.

One challenge with operating a degausser apparatus for bulk or continuous erasure of multiple magnetic media is a lack of prior knowledge on the media that are entering the degausser apparatus. The methods described herein do not require prior knowledge on the magnetic media being fed to the degausser apparatus. Instead, the methods determine a timing, for example a discharge delay, using variables determined by position detectors associated with the degausser apparatus. Using such variables, a controller can determine characteristics (e.g., length, velocity, acceleration) of the magnetic media, to control the timing of the degaussing operation performed by the degausser apparatus.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B. Similarly, the word “or” when used herein shall be interpreted as having a disjunctive construction rather than a conjunctive construction unless otherwise specifically indicated.

The singular forms “a”, “an”, and “the” include plural references unless the context clearly dictates otherwise.

The terms and expressions used herein have the ordinary technical meaning as is accorded to such terms and expressions by persons having ordinary skill in the technical field as set forth above except where different specific meanings have otherwise been set forth herein. The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

While there have been illustrated and described particular embodiments, it will be appreciated that numerous changes and modifications will occur to those skilled in the art, and it is intended for the present disclosure to cover all those changes and modifications that fall within the scope of the appended claims.

What is claimed is:

1. A system for electromagnetic erasure of magnetic storage media, the system comprising:
a magnetic field generator configured to perform a degaussing operation on a magnetic media;
a set of position detectors comprising a first position detector and a second position detector, the set of position detectors disposed at known distances from the magnetic field generator; and
a controller operatively coupled with the magnetic field generator and the set of position detectors, the controller configured to:
receive first data from the set of position detectors, the first data indicative of the presence of the magnetic media relative to the set of position detectors;
determine a characteristic of the magnetic media based on the first data; and
control a timing for the degaussing operation based on the characteristic.

2. The system of claim 1, wherein the characteristic includes at least one of a velocity of the magnetic media, a length of the magnetic media, or an acceleration of the magnetic media.

3. The system of claim 1, wherein the system further comprises an oscillator configured to output counts at a predetermined frequency to track time for the system, and wherein the controller is further configured to receive second data from the oscillator and determine the characteristic based at least in part on the second data.

4. The system of claim 3, wherein the first position detector is a first laser gate and the second position detector is a second laser gate, and wherein the controller is further configured to:
detect a first exit of the magnetic media from the first laser gate, the first exit indicating when the magnetic media clears the first laser gate;
detect a second exit of the magnetic media from the second laser gate, the second exit indicating when the magnetic media clears the second laser gate;
determine a number of oscillations between the first exit and the second exit; and
determine an exit velocity of the magnetic media based on the number of oscillations between the first exit and the second exit.

5. The system of claim 4, wherein the controller is further configured to:
determine a number of counts that pass while the second laser gate is interrupted by the magnetic media; and
determine a length of the magnetic media based on the exit velocity and the number of counts.

6. The system of claim 5, wherein the controller is further configured to:
determine an acceleration of the magnetic media based at least in part on the exit velocity.

7. The system of claim 6, wherein the controller is further configured to:
determine the timing of the degaussing operation based on at least one the acceleration of the magnetic media, the length of the magnetic media, and the exit velocity of the magnetic media.

8. The system of claim 1, wherein the set of position detectors is a first set of position detectors, and wherein the system further comprises:
a second set of position detectors, the second set of position detectors disposed known distances from the magnetic field generator, the controller communicatively coupled to the second set of position detectors.

9. The system of claim 8, wherein the controller is further configured to:
receive third data from the second set of position detectors, the third data indicative of the presence of the magnetic media relative to the second set of position detectors;
determine an outlet characteristic of the magnetic media based on the third data, the outlet characteristic of the magnetic media defining a property of the magnetic media after the degaussing operation has been performed to erase the magnetic media; and
calibrate the timing of the degaussing operation based on the outlet characteristic of the magnetic media.

10. The system of claim 1, further comprising:
an entry slot for receiving magnetic media into the system;
wherein the controller is further configured to control an electrically operated gate at the entry slot to regulate introduction of the magnetic media into the system.

11. The system of claim 1, further comprising:
a translation mechanism for moving the magnetic media through the magnetic field generator.

12. The system of claim 11, wherein the translation mechanism is a slide or a chute.

13. The system of claim 11, wherein the translation mechanism is disposed at an angle of between about 10 degrees and about 90 degrees relative to the floor.

14. The system of claim 1, wherein the magnetic field generator is a capacitive degausser.

15. The system of claim 1, further comprising:
a destruction device disposed downstream of the magnetic field generator;
wherein the magnetic media is gravity fed to the destruction device from the magnetic field generator.

16. A system for electromagnetic erasure of magnetic storage media, the system comprising:
a magnetic field generator for performing a degaussing operation on a magnetic media;
a set of photodetectors configured to detect photon beams from a set of transmitters, the set of photodetectors disposed a known distance from an entry of the magnetic field generator;
a sorting system disposed downstream of the magnetic field generator for directing the magnetic media to one of a plurality of destruction devices; and
a controller operatively coupled to the magnetic field generator, the set of photodetectors, and the sorting system, the controller configured to:
receive data from the set of photodetectors, the data indicative of the magnetic media interrupting the photon beams;
determine a size of the magnetic media based on the data; and
control the sorting system to direct the magnetic media to one of the plurality of destruction devices based on the size of the magnetic media.

17. The system of claim 16, further comprising:
a translation mechanism for moving the magnetic media through the magnetic field generator and into the sorting system.

18. The system of claim 16, wherein the system further comprises an oscillator configured to output pulses at a predetermined frequency to track time for the system, and wherein the controller is further configured to receive second data from the oscillator and determine the size based at least in part on the second data.

19. A system for degaussing magnetic media, the system comprising:
a magnetic field generator for performing a degaussing operation on a magnetic media;
an inductance sensing circuit configured to monitor an inductance of the magnetic field generator; and
a controller operatively coupled to the magnetic field generator and the inductance sensing circuit, the controller configured to:
receive data including the inductance of the magnetic field generator from the inductance sensing circuit, the data indicative of a position of the magnetic media within a magnetized volume of the magnetic field generator; and
control a timing of the degaussing operation based on the data.

20. The system of claim 19, wherein the controller initiates the degaussing operation upon detecting a peak in the inductance of the magnetic field generator.
